(19) United States
(12) Patent Application Publication
(10) Pub. No.: US 2010/0020916 A1
(43) Pub. Date: Jan. 28, 2010

(54) NUCLEAR REACTOR FUEL ASSEMBLY GRID

(76) Inventors: Richard P. Broders, Granby, CT (US); Paul M. Evans, Chapin, SC (US)

Correspondence Address: WESTINGHOUSE ELECTRIC COMPANY, LLC, P.O. BOX 355, PITTSBURGH, PA, 15230-0355, US

(21) Appl. No.: 11/764,540

(22) Filed: Jun. 18, 2007

(51) Int. Cl. G21C 3/34

(52) U.S. Cl. 376/442

(57) ABSTRACT

An elongated through-grid split sleeve is used to secure a nuclear fuel assembly spacer grid axially within a fuel assembly. The split sleeve has windows extending along an axial dimension equal to the height of the cell walls through which control rod guide thimbles extend with the sleeve having an overall axial dimension that extends the sleeve above and below the cell walls. The sleeve is inserted into the guide thimble tube openings of a welded spacer grid assembly by squeezing the split sleeve to collapse its diameter to fit into the opening. The collapsed sleeve is inserted into the opening and then released when in position, thus locking it into position within the grid. The spacer grid assembly is then assembled into the fuel assembly skeleton structure and secured into position by welding the split sleeves to the guide thimble tubes.

### BACKGROUND OF THE INVENTION

1. Field of the Invention

The present invention relates generally to nuclear reactor fuel assembly grids and, more particularly, is concerned with the connection between the fuel assembly grid straps and the control rod guide thimbles.

2. Description of the Related Art

In a typical nuclear reactor, the reactor core includes a large number of fuel assemblies, each of which is composed of top and bottom nozzles with a plurality of elongated, transversely spaced guide thimbles extending longitudinally between the nozzles and a plurality of transverse support grids axially spaced along and attached to the guide thimbles. Also, each fuel assembly is composed of a plurality of elongated fuel elements or rods transversely spaced apart from one another and from the guide thimbles, and supported by the transverse grids between the top and bottom nozzles. The fuel rods each contain fissile material and are grouped together in an array which is organized so as to provide a neutron flux in the core sufficient to support a high rate of nuclear fission, and thus the release of a large amount of energy in the form of heat. A liquid coolant is pumped upwardly through the core in order to extract some of the heat generated in the core for the production of useful work. Since the rate of heat generation in the reactor core is proportional to the nuclear fission rate, and this, in turn, is determined by the neutron flux in the core, control of heat generation at reactor start-up, during operation, and at shut down is achieved by varying the neutron flux. Generally this is done by absorbing excess neutrons using control rods which contain neutron absorbing material. The guide thimbles, in addition to being structural elements of the fuel assembly, also provide channels for insertion of the neutron absorber control rods within the reactor core. The level of neutron flux, and thus the heat output of the core is normally regulated by the movement of the control rods into and from the guide thimbles.

The guide thimbles are rigidly connected at each end respectively to the top nozzle and bottom nozzle and the grids are fixably attached to the guide thimbles at the cell locations through which the guide thimbles pass. The top nozzle, bottom nozzle, guide thimbles and grids thus form the structural elements of the fuel assembly also known as the fuel assembly skeleton.

The grids are used to precisely maintain the spacing between fuel rods in a nuclear reactor core, prevent rod vibration, and provide lateral support for the fuel rods. Grids are made of materials with low neutron absorption cross-sections such as stainless steel, inconel, and alloys of zirconium, such as zircaloy, to minimize grid deformation and the loss of structural integrity during a radiation. Conventional designs of grids for nuclear fuel assemblies include a multiplicity of interleaved interior grid straps formed in an egg-crate configuration defining cells which accept the fuel rods and the guide thimbles. The ends of each of the interior grid straps are interlocked with an outer grid strap, forming the peripheral cells of the grid. Each cell through which the fuel rods pass provide support to one fuel rod at a given axial location through the use of relatively resilient springs of various forms. In order to minimize the lateral displacement of fuel rods and to improve the fuel characteristics of an assembly, a number of grids are spaced along the fuel assembly length. In a pressurized water reactor, typically each grid is held in place along the fuel assembly by its attachment to the control rod guide thimbles.

The interior straps of the grids that are interlocked in an egg-crate pattern are generally held in place by a welded or braised joint at their intersecting locations. The ends of the lattice straps are similarly affixed to the perimeter straps that surrounds them by welds or braises. If the straps are made of zircaloy or stainless steel, they can generally be welded. If inconel or nickel plated inconel are employed, they generally have to be braised. Various means of attachment are used to position and secure the spacer grid assemblies to the guide thimble tubes. These means of attachment include welding of the grids to the tubes, braising, bulging of the tubing into sleeves that are attached to the grids, and welding split rings 40 to the guide thimbles 18 directly above and below the grid straps 42 as shown in FIG. 1. The latter two mechanical approaches to connecting the guide thimbles to the grids straps is necessary where dissimilar materials are employed for the grid straps and the guide thimbles, e.g., inconel grids and zircaloy guide thimbles. With individual split rings 40 used on either side of the grid straps 42, issues can arise due to the size of the gaps between the rings 40 and the grid straps 42, which can result in uneven loading of the rings 40, lack of coplanarity of the rings 40, and difficulties inspecting the ring to grid gaps.

Designers are constantly seeking to improve the means of manufacture of the grids and fuel assembly skeletons. Areas of interest include mechanisms for reducing the manufacturing effort, and meeting the stringent design envelope, or tolerances, on dimensional parameters of the grid. Furthermore, considerations include retaining the structural rigidity of the fuel assembly skeleton. More particularly, the need specifically exists for an improved connection between the grid straps and the guide thimbles that will accommodate the use of dissimilar materials for the grid straps and the guide thimbles. While zircaloy has a lower neutron capture cross section than inconel, inconel has a greater stiffness and a lower relaxation rate than zircaloy and thus is more desirable for use as a grid strap material.

### SUMMARY OF THE INVENTION

This invention achieves an improvement in the manufacture of nuclear fuel assemblies by providing an improved connection between the grid straps surrounding the cells through which the guide thimbles pass and the guide thimbles. The improvement comprises a through grid split sleeve that extends from above the grid straps to a distance below the grid straps. The uncompressed diameter of the sleeve is equal to or larger than the diameter of the cell through which the guide thimble extends. Preferably, the sleeve is made of a resilient material that is the same as or similar to that of the guide thimble. The sleeve is compressed and in its compressed condition it is inserted through the corresponding cell of the grid with a portion of the sleeve extending above and below the grid straps. The sleeve is then allowed to expand to its uncompressed condition, thereby securing the sleeve within the guide thimble cell. In the case where the materials of the sleeve grid straps are compatible the sleeve may be welded to the grid strap. When the sleeve is secured within the cell, the guide thimble can be inserted and welded or braised at either end of the sleeve or at both ends of the sleeve.

In the preferred embodiment, the split sleeve of this invention has windows stamped in the sleeve with an opening height equal to the height of the grid straps. When the split sleeve is inserted into the corresponding guide thimble cell and allowed to expand, the upper and lower horizontal ledges of the windows in the sleeve rest upon the upper and lower edges of the grid strap locking the sleeve into its axial position. The guide thimbles may then be inserted and welded into position after the axial location of the grid is fixed.

In alternate embodiments, the axial slit in the sleeve may be formed between windows, at the edge of one window or fully within one window depending on the amount of diameter reduction required to insert the sleeve into the grid's guide thimble cell opening. Desirably, in the embodiments employing windows to axially secure the sleeve with respect to the grid strap, the expanded sleeve exerts an approximately zero lateral force on the grid strap walls within which it is secured.

### BRIEF DESCRIPTION OF THE DRAWINGS

A further understanding of the invention can be gained from the following description of the preferred embodiments when read in conjunction with the accompanying drawings in which:

FIG. 1 is a perspective view of prior art split ring connection of a guide thimble to a fuel grid cell;

FIG. 2 is an elevational view of the fuel assembly, illustrated in vertically shortened form, and a control assembly therefore, partially shown in hidden line drawing;

FIG. 3 is a plan view of the grid support assembly of this invention showing the general grid pattern confined within a perimeter strap;

FIG. 4 is a perspective view of one embodiment of the through grid split sleeve control rod guide thimble to grid cell connection of one embodiment of this invention;

FIG. 5 is a perspective view of the through grid split sleeve of this invention inserted within a guide thimble tube cell of a fuel assembly grid; and

FIGS. 6A and 6B are perspective views of two embodiments of the windows within the through grid split sleeve of this invention.

### DESCRIPTION OF THE PREFERRED EMBODIMENTS

For simplicity, this invention will be described with reference to a pressurized water reactor, though it should be appreciated that this invention may be used with other reactor designs that employ similar guide tubes within a support cell structure. Accordingly, reference to a pressurized water reactor is not meant to be limiting upon the scope of the invention.

Directional phrases used herein, such as, for example, upper, lower, top, bottom, left, right, and derivatives thereof for the most part relate to the orientation of the elements shown in the drawings and are not meant to be limiting upon the claims, unless expressly recited therein. As employed herein, the statement that two or more parts are “coupled” together shall mean that the parts are joined together, either directly or joined through one or more intermediate parts. In addition, as employed herein, the term “number” shall refer to one and more than one, i.e., a plurality.

### Fuel Assembly

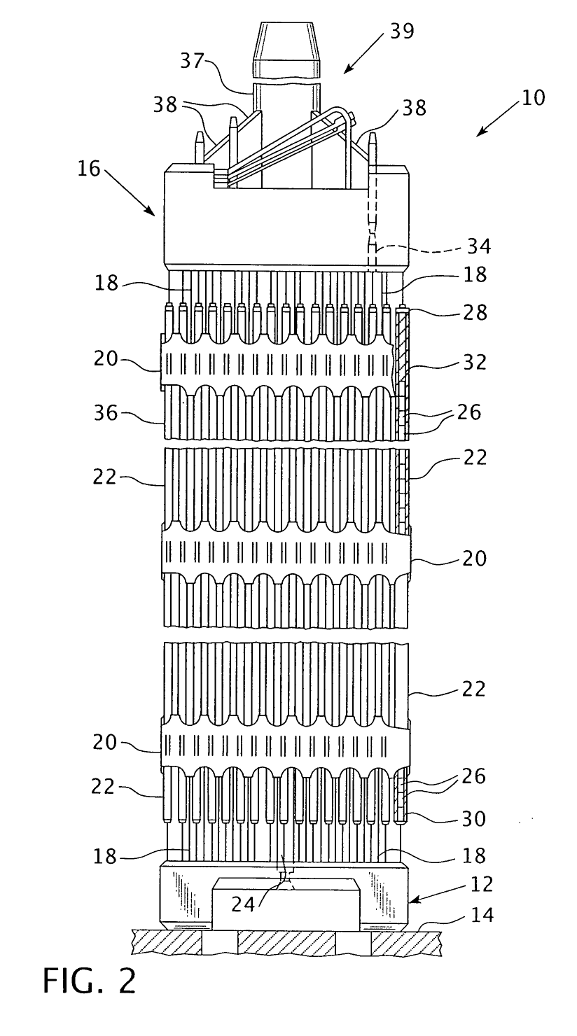

Referring now to the drawings, and particularly to FIG. 2, there is shown an elevational view of a nuclear reactor fuel assembly, represented in vertically shortened form and being generally designated by reference character 10. The fuel assembly 10 is the type used in a pressurized water reactor and has a structural skeleton which, at its lower end, includes a nozzle 12 for supporting the fuel assembly 10 on a lower core support plate 14 in the core region of the nuclear reactor (not shown), a top nozzle 16 at its upper end, and a number of guide tubes or thimbles 18 which extend longitudinally between and are rigidly coupled at opposite ends to the bottom and top nozzles 12 and 16.

The fuel assembly 10 further includes a plurality of transverse grids 20 axially spaced along and mounted to the guide thimble tubes 18 and an organized array of elongated fuel rods 22 transversely spaced and supported by the grids 20. The assembly 10 also has an instrumentation tube 24 located in the center thereof and extending between and mounted to the bottom and top nozzles 12 and 16. In view of the foregoing arrangement of parts, it should be understood that the fuel assembly 10 forms an integral unit capable of being conveniently handled without damaging the assembly of parts.

As previously discussed, the array of fuel rods 22 in the fuel assembly 10 are held in spaced relationship with one another by the grids 20 which are spaced along the fuel assembly length. Each fuel rod 22 includes nuclear fuel pellets 26 and is closed at its opposite ends by upper and lower end plugs 28 and 30. The pellets 26 are maintained in a stack by a plenum spring 32 disposed between the upper end plug 28 and the top of the pellet stack. The fuel pellets 26, composed of fissile material, are responsible for creating the reactive power of the reactor. A liquid moderator/coolant such as water, or water containing boron, is pumped upwardly through a plurality of How openings in the lower core plate 14 to the fuel assembly. The bottom nozzle 12 of the fuel assembly 10 passes the coolant upwardly through the guide tubes 18 and along the fuel rods 22 of the assembly, in order to extract heat generated therein for the production of useful work. To control the fissile process, a number of control rods 34 are reciprocally movable in the guide tubes 18 located at pre-determined positions in the fuel assembly 10. A spider assembly 39 positioned above the top nozzle 16 supports the control rods 34.

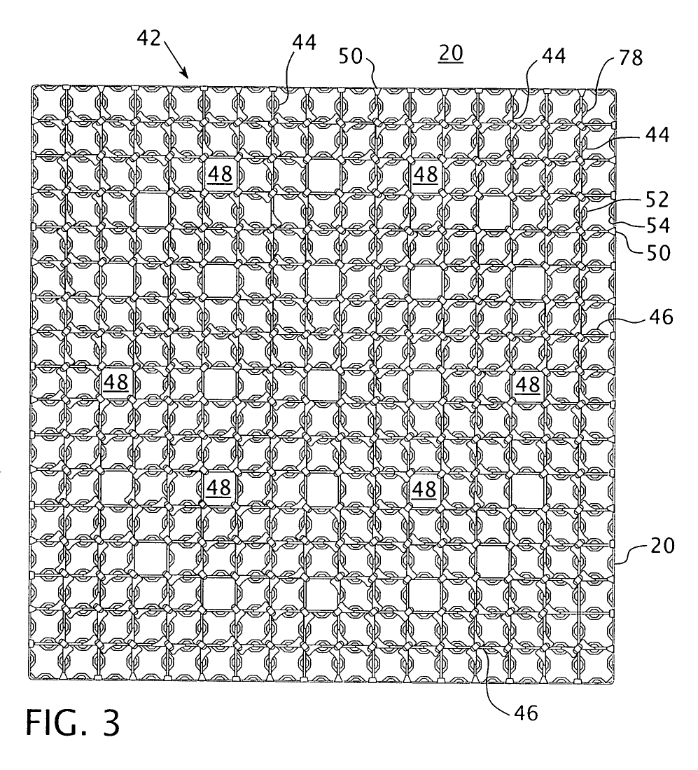

FIG. 3 illustrates a 17 by 17 array of cells, though it should be appreciated that the application of the principles of this invention are not affected by the number of fuel rods 22 in the fuel assembly 10. The lattice straps which form the orthogonal members 44 and 46 shown in FIG. 3, are substantially identical in design. While the lattice straps 44 and 46 are substantially identically, it should be appreciated that the design of some of the straps 44 will vary from other lattice straps 44 as well as some straps 46 vary from other straps 46, to accommodate the guide thimbles 18, as can better be appreciated by reference to FIG. 3, which shows the location of the thimble cells 48 that accommodate the thimble tubes 18.

As previously mentioned, the interior lattice work of conventional designs of grids 20 for nuclear reactor fuel assemblies 10 include a multiplicity of interleaved, inner straps 44 and 46 forming an egg-crate configuration defining cells which accept fuel rods 22. The interleaved design is enabled by vertical cut opposing slots in the inner straps 44 and 46 at the intersecting locations, which interlock to form the egg crate configuration, as is commonly known in the art. The ends of each of the inner grid straps 44 and 46 are connected to an outer grid strap 50 to form the peripheral cells of the grid 20. Most of the individual cells of the grid 20 provide support for one fuel rod 22 at a given axial location through the use of the combination of relatively resilient springs 52 and dimple 54 of various forms. The outer grid strap 50 encloses the inner grid straps 44 and 46 to impart strengthen rigidity to the grid 20. The cells 48 through which the guide thimble extend can be identified in FIG. 2 as the cells without dimples or springs.

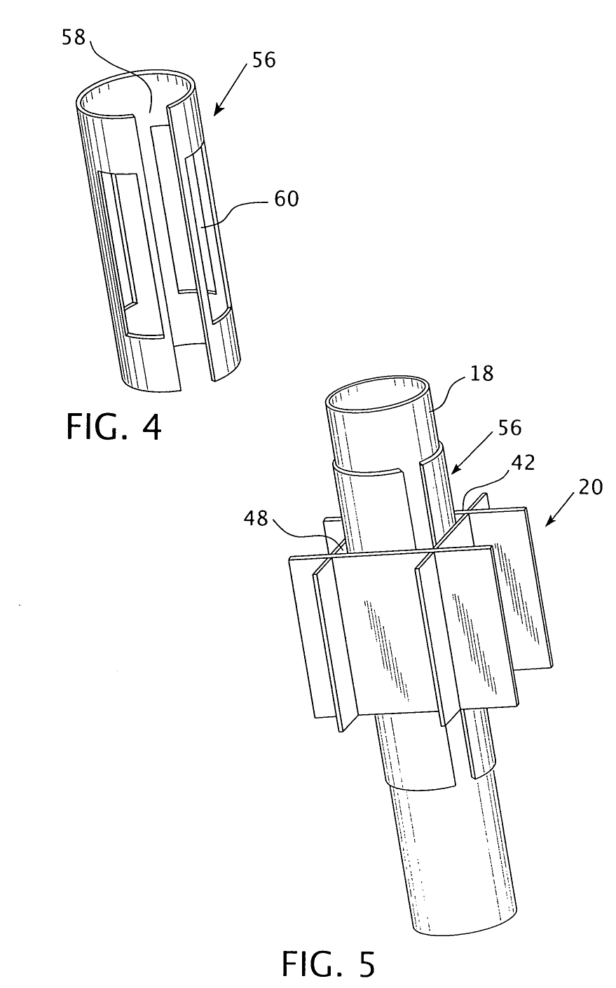

In accordance with this invention, the control rod guide thimbles are attached to the grid straps 44 and 46 surrounding the cells 48 employing a through grid split sleeve 56, one embodiment of which is illustrated in FIG. 4. The slit 58 in the sleeve 56 enables the sleeve to be compressed whenever it is inserted within the grid cells 48. The sleeve is inserted into the guide thimble/instrument tube openings of the welded spacer grid assembly 20 by squeezing the split sleeve to collapse its diameter to fit into the opening. The collapsed sleeve is then inserted into the opening and then released in position so that the sleeve extends preferably an equal distance above and below the grid straps 44 and 46. In one preferred embodiment, the sleeve is provided with windows 60 that extend in height equal to the width of the grid straps 44 and 46. When the sleeve 56 is expanded within the cell 48, the upper ledge of the window 60 rests upon the upper edge of the grid straps 42 and the lower ledge of the window 60 rests against the lower edge of the grid straps 42 locking the sleeve axially in position. Preferably in this configuration, the uncompressed diameter of the sleeve is substantially equal to or slightly greater than the width of the cell 48 so that substantially no lateral force is exerted against the walls of the cell 48. Alternatively the through grid split sleeve 56 can be provided without windows and where compatible materials are employed for the sleeve 56 and the grid straps 42 the sleeve can be welded or brazed to the grid straps at the upper and/or lower edges of the straps 42 where they mate with the sleeve 56. In another embodiment, the grid straps can be provided with dimples that extend inwardly into the cell 48 that capture the window 60 at its upper and lower extents to secure the sleeve 56 axially within the cell 48. Furthermore, the uncompressed diameter of the sleeve can be made slightly larger than the width of the cell 48 to secure the sleeve within the cell by frictional forces while the sleeve is welded or brazed to facilitate manufacture. After the sleeve 56 is secured within the grid cell 48 the spacer grid cell assembly 20 would then be assembled into the skeleton structure of the fuel assembly 10 and secured in position by welding of the split sleeves to the guide thimbles/instrument tubes. FIG. 5 shows the through-grid split sleeve 56 positioned within the grid cell 48 with the guide thimble tube 18 inserted through the through-grid split sleeve 56 and the grid opening 48.

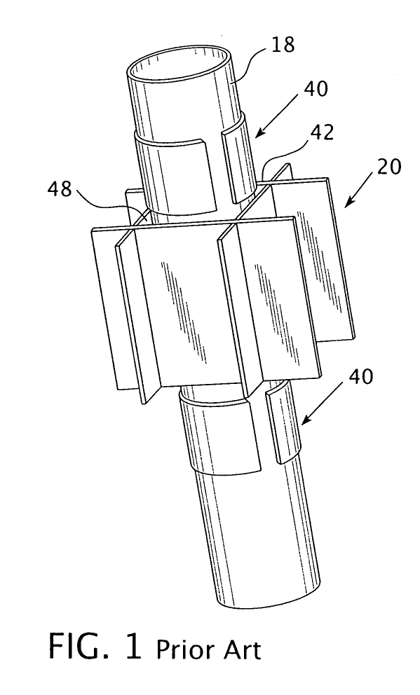

The preferred embodiment of the through-grid split sleeve 56 of this invention provides a number of advantages over the current split ring design 40 shown in FIG. 1, that are secured above and below the grid 20 in regard to the design, manufacture, and product assurance. From a design perspective, the openings or “windows” in the sleeve can be sized to control both the lateral and axial fit of the sleeve within the assembled grid 20. By controlling the height of the windows 60, the axial gaps between the sleeve windows and the inner straps 42 of the grid 20 can be held significantly tighter than with individual split rings 40 above and below the grid 20. Minimizing the gaps in this way improves the coplanarity of the sleeves, thus improving the angular alignment of the grid 20 relative to the guide thimble tubes 18. Another design advantage is that the welds between the through-grid split sleeve 56 and the guide thimble tube on both sides of the grid 20 contribute to the attachment strength when loaded in either direction. With the current split rings 40, the attachment strength is only due to the welds on one side of the grid. From a manufacturing perspective, the through-grid split sleeve 56, employing the windows 60, once installed in the welded grid assembly 20, is automatically located and positioned, ready for welding once the guide thimbles are inserted and the grid is located axially. With the current split rings 40, each individual ring needs to be held relative to the grid and fabrication experience has shown that the gap sizes are difficult to control. From a product assurance perspective, the inspections required after welding are reduced and simplified with the through-grid split sleeve design 56 because the windows 60 in the through-grid split sleeve 56 control the sleeve to grid gaps so no inspection of the gaps would be required. With the current split rings 40, the gaps between each ring and the grid straps 42 must be inspected. This is a difficult and time consuming task due to the small gap requirement and the inaccessibility of the gaps.

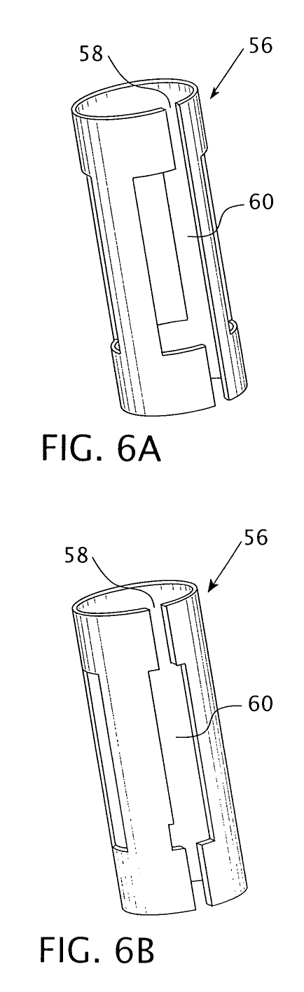

FIG. 4 illustrates the preferred embodiment of the through-grid split sleeve 56 and the benefits that the design offers. Two alternate configurations of the through-grid split sleeve design are shown in FIGS. 6A and 6B, where the location of the split 58 has been moved to the edge of the window 60 or fully within the windows 60. These alternate configurations may be preferable in some cases, depending on the diameter reduction required to insert the sleeve into the grid's guide thimble opening.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only, without limiting as to the scope of the invention, which is to be given the full breadth of the appended claims and any and all equivalents thereof.

What is claimed is:

1. A fuel assembly for a nuclear reactor comprising:
a top end fitting;
a bottom end fitting;
a plurality of elongated guide thimbles respectively extending between and connected at opposite ends to the top end fitting and the bottom end fitting; and
a plurality of transverse grids arranged in a spaced tandem array between the top end fitting and the bottom end fitting, at least some of said grids formed from a plurality of orthogonal intersecting straps that define cells at the intersection of each four adjacent straps, the guide thimbles respectively extending through and fixedly connected to at least some of said cells, the connection between at least some of said guide thimbles and at least some of the corresponding cells through which the guide thimbles pass comprising;
an elongated tubular sleeve constructed from a resilient material, the sleeve having an axial dimension with a slit extending through the surface of the sleeve along the axial dimension over an entire axial length of the sleeve, the length of the sleeve being longer than a width in the axial direction of the grid straps of the cell through which the corresponding guide thimble passes and having an uncompressed diameter that is larger than or equal to an axially transverse width of the cell through which the corresponding guide thimble passes, the elongated tubular sleeve extending through and above and below the cell through which the corresponding guide thimble passes and being mechanically or metallurgically affixed to at least a one wall of the cell through which the corresponding guide thimble passes, the guide thimble extending through the corresponding sleeve and metallurgically or mechanically secured to the sleeve at an upper and lower end of the sleeve.

2. The fuel assembly of claim 1 wherein a window is formed in the sleeve, the window having a top ledge and a bottom ledge, the spacing between the top ledge and the bottom ledge being substantially equal to the width of the grid straps, in the axial direction, that surround the sleeve when the sleeve is inserted into the cell.

3. The fuel assembly of claim 2 wherein the top ledge rests at least partially on the upper edge of the grid straps that surround the sleeve.

4. The fuel assembly of claim 3 wherein the bottom ledge rests at least partially against a lower edge of the grid straps that surround the sleeve.

5. The fuel assembly of claim 2 wherein the window is stamped in a wall of the sleeve.

6. The fuel assembly of claim 2 wherein the window is formed in a wall of the sleeve offset from the axial slit.

7. The fuel assembly of claim 2 wherein the window is formed in a wall of the sleeve spanning the axial slit.

8. The fuel assembly of claim 1 wherein the sleeve is mechanically attached to the wall of the cell through which it extends by spring forces exerted radially by the compressed sleeve.

9. The fuel assembly of claim 2 wherein a window is formed in the sleeve and a protrusion is formed on the wall of the cell through which the sleeve is positioned and extends into and axially captures the window so that the sleeve cannot move axially with respect to the grid.

10. The fuel assembly of claim 1 wherein the sleeve is welded or brazed to the grid strap.

11. The fuel assembly of claim 1 wherein the uncompressed sleeve exerts substantially a zero axially transverse force outwardly on the wall of the cell through which the sleeve extends.

12. A grid for a nuclear fuel assembly comprising:
a plurality of orthogonal intersecting straps that define cells at the intersection of each four adjacent straps, at least some said cells designed to be connected to a corresponding number of guide thimbles that respectively pass therethrough, the connection between at least some of said guide thimbles and at least some of the corresponding cells through which the guide thimbles are designed to pass through comprising;
an elongated tubular sleeve constructed from a resilient material, the sleeve having an axial dimension with a slit extending through the surface of the sleeve along the axial dimension over an entire axial length of the sleeve, the length of the sleeve being longer than a width in the axial direction of the grid straps of the cell through which the corresponding guide thimble is designed to pass through and having an uncompressed diameter that is larger than or equal to an axially transverse width of the cell through which the corresponding guide thimble is designed to pass through, the elongated tubular sleeve extending through and above and below the cell through which the corresponding guide thimble is designed to pass through and being mechanically or metallurgically affixed to at least a one wall of the cell through which the corresponding guide thimble is designed to pass through.
